(19) United States
(12) Patent Application Publication
(10) Pub. No.: US 2015/0202545 A1
(43) Pub. Date: Jul. 23, 2015

(54) SELECTIVE SEPARATION AND CONCENTRATION SYSTEM FOR WATER SOLUBLE SALTS

(71) Applicant: HEARTLAND TECHNOLOGY PARTNERS LLC, St Louis, MO (US)

(72) Inventors: Bernard F. Duesel, JR., Goshen, NY (US); Michael J. Rutsch, Pittsburgh, PA (US); Craig Clerkin, Stoughton, WI (US)

(21) Appl. No.: 14/598,738

(22) Filed: Jan. 16, 2015

Related U.S. Application Data
(60) Provisional application No. 61/928,688, filed on Jan. 17, 2014.

(51) Int. Cl. B01D 1/00; C02F 1/04; B01D 21/26; B01D 21/24; B01D 21/00

(52) U.S. Cl. CPC B01D 1/0064; B01D 21/2488; B01D 21/009; B01D 21/245; B01D 21/262; C02F 1/048; C02F 2209/02; C02F 2103/06

(57) ABSTRACT

A direct contact liquid concentrator selectively separates and concentrates water soluble salts from a wastewater stream containing two or more water soluble salts by concentrating the wastewater stream until the concentrated wastewater stream approaches or reaches a saturation level of the first water soluble salt; delivering the concentrated wastewater to a first settling tank, where the first water soluble salt begins to precipitate out of solution in solid form; drawing a first liquid solution from the first settling tank and sending the liquid solution to a second settling tank; and drawing a second liquid solution from the second settling tank, the second liquid solution having a higher ratio of a second water soluble salt to the first water soluble salt than the first liquid solution.

This application claims the benefit of Provisional U.S. Patent Application No. 61/928,688, filed Jan. 17, 2014, the entirety of which is incorporated herein by reference.

### BACKGROUND

1. Field of the Disclosure

This application relates generally to separation and concentration systems for water soluble salts, and more specifically to such systems that comprise direct contact liquid concentrators that selectively separate and concentrate water soluble salts from a liquid stream containing two or more water soluble salts.

2. Background of the Disclosure

Some types of wastewater contain water soluble salts in differing concentrations. For example, some types of wastewater from natural gas wells (typically called produced water or flowback water) can include varying levels of certain salts, such as sodium chloride and potassium nitrate, for example, although virtually any type of water soluble salt may be found in wastewater. Previously, the volumes of such wastewaters have been reduced through evaporation in evaporation ponds, or through concentration in wastewater concentrators. For example, wastewater concentrators, such as those disclosed in U.S. patent application Ser. No. 12/705,462, filed Feb. 12, 2010, U.S. patent application Ser. No. 12/846,257, filed Jul. 29, 2010, U.S. patent application Ser. No. 12/846,337, filed Jul. 29, 2010, and U.S. patent application Ser. No. 12/938,879, filed Nov. 3, 2010, the entirety of each of which is hereby incorporated by reference herein, have been used to remove a portion of liquid water found in the wastewaters to reduce transportation and disposal costs. However, while such concentration reduces overall volume and results in higher concentrations of the water soluble salts, the ratios of the dissolved salts remains the same. For example, if the ratio of sodium chloride to potassium nitrate was 1:2 before concentration, the ratio will also be 1:2 after concentration.

In certain cases, one or more of the dissolved salts may be valuable while other dissolved salts are not valuable. Currently there is no way to separate the valuable salts from the non-valuable salts, or otherwise change the concentration ratios between the two salts.

### BRIEF DESCRIPTION OF THE DRAWINGS

FIG. 1 is a perspective view of one example of a compact liquid concentrator that may be used in a water soluble salt selective separation and concentration system;

FIG. 2 is a perspective view of a heat transfer portion of the compact liquid concentrator of FIG. 1;

FIG. 3 is a front perspective view of an evaporator/concentrator portion of the compact liquid concentrator of FIG. 1;

FIG. 4 is a schematic diagram of a control system which may be used in the liquid concentrator of FIG. 1 to control the operation of the various component parts of the liquid concentrator;

FIG. 5 is a solubility graph for sodium chloride and potassium nitrate based on temperature;

FIG. 6 is a schematic diagram of a selective salt separation and concentration system that comprises a liquid concentrator and a concentration adjustment system; and

FIG. 7 is a schematic diagram of a second embodiment of a selective salt separation and concentration system that comprises a liquid concentrator and a concentration adjustment system.

### DETAILED DESCRIPTION

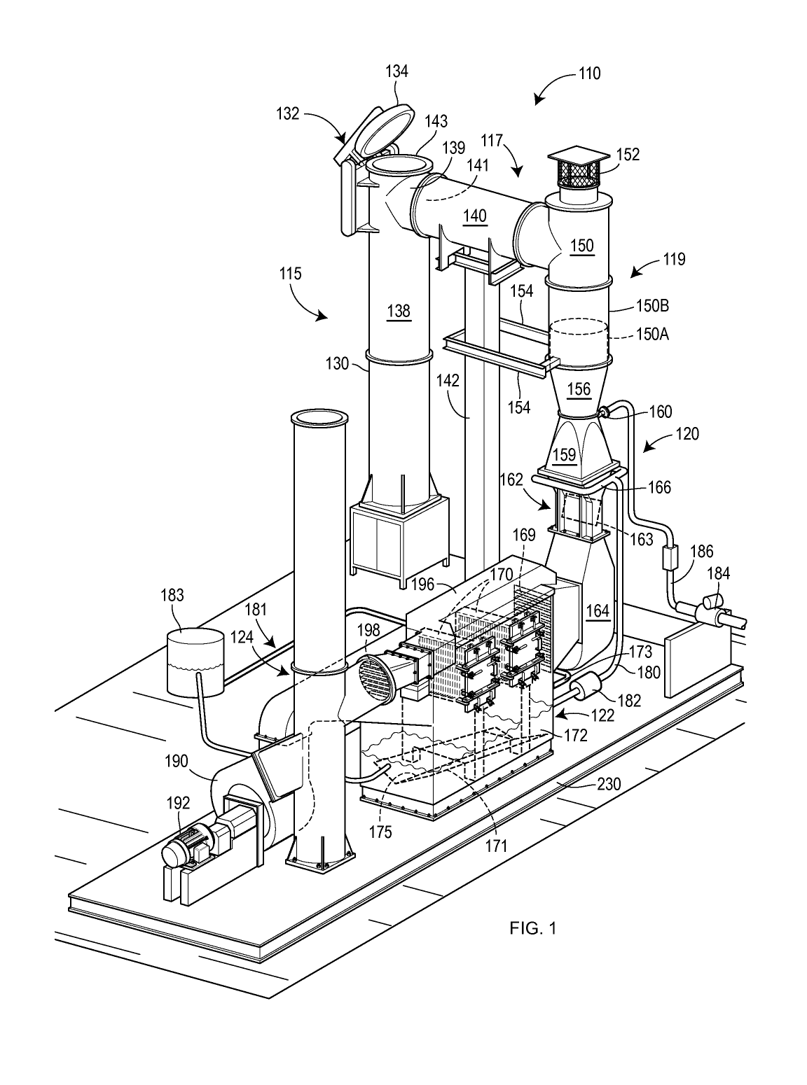

FIG. 1 illustrates one embodiment of a liquid concentrator 110 that may be used in a selective salt separation and concentration system. Generally speaking, the liquid concentrator 110 operates to concentrate wastewater, such as flowback water or produced water from natural gas wells, using exhaust or waste heat created within a flare which burns a fuel, for example, natural gas. Other types of fuels may be burned in the flare, for example, landfill gas, fossil fuels, and renewable fuels, such as wood or paper. Typically, the gas exiting the flare is between 1200 and 1500 degrees Fahrenheit and may reach 1800 degrees Fahrenheit. The liquid concentrator 100 is equally effective in concentrating other types of wastewater.

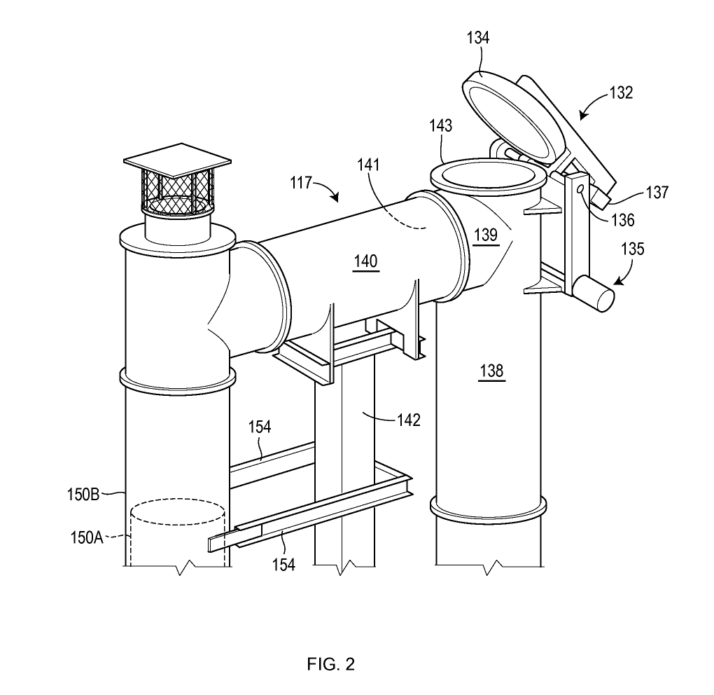

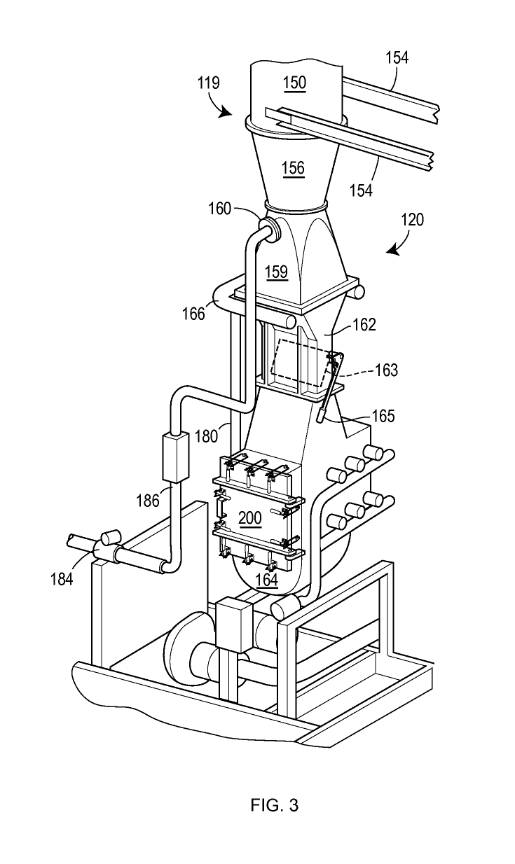

As illustrated in FIG. 1, the liquid concentrator 110 generally includes or is connected to a flare assembly 115, and includes a heat transfer assembly 117 (shown in more detail in FIG. 2), an air pre-treatment assembly 119, a concentrator assembly 120 (shown in more detail in FIG. 3), a fluid scrubber 122, and an exhaust section 124. However, in other embodiments, the flare assembly 115 may be separated from the liquid concentrator 110, or eliminated from the liquid concentrator 110 altogether (in the later case, the liquid concentrator 110 may use heat from a source other than a flare). The flare assembly 115 includes a flare 130 and a flare cap assembly 132. The flare cap assembly 132 includes a movable cap 134 (e.g., a flare cap, an exhaust gas cap, etc.) which covers the top of the flare 130, or other type of stack (e.g., a combustion gas exhaust stack), to seal off the top of the flare 130 when the flare cap 134 is in the closed position, or to divert a portion of the flare gas in a partially closed position, and which allows gas produced within the flare 130 to escape to the atmosphere through an open end that forms a primary gas outlet 143, when the flare cap 134 is in an open or partially open position. The flare cap assembly 132 also includes a cap actuator 135, such as a motor (e.g., an electric motor, a hydraulic motor, a pneumatic motor, etc., shown in FIG. 2) which moves the flare cap 134 between the fully open and the fully closed positions. As illustrated in FIG. 2, the flare cap actuator 135 may, for example, rotate or move the flare cap 134 around a pivot point 136 to open and close the flare cap 134. The flare cap actuator 135 may utilize a chain drive or any other type of drive mechanism connected to the flare cap 134 to move the flare cap 134 around the pivot point 136. The flare cap assembly 132 may also include a counter-weight 137 disposed on the opposite side of the pivot point 136 from the flare cap 134 to balance or offset a portion of the weight of the flare cap 134 when moving the flare cap 134 around the pivot point 136. The counter-weight 137 enables the actuator 135 to be reduced in size or power while still being capable of moving or rotating the flare cap 134 between an open position, in which the top of the flare 130 (or the primary combustion gas outlet 143) is open to the atmosphere, and a closed position, in which the flare cap 134 covers and essentially seals the top of the flare 130 (or the primary combustion gas outlet 143). The flare cap 134 itself may be made of high temperature resistant material, such as stainless steel or carbon steel, and may be lined or insulated with refractory material including aluminum oxide and/or zirconium oxide on the bottom portion thereof which comes into direct contact with the hot flare gases when the flare cap 134 is in the closed position.

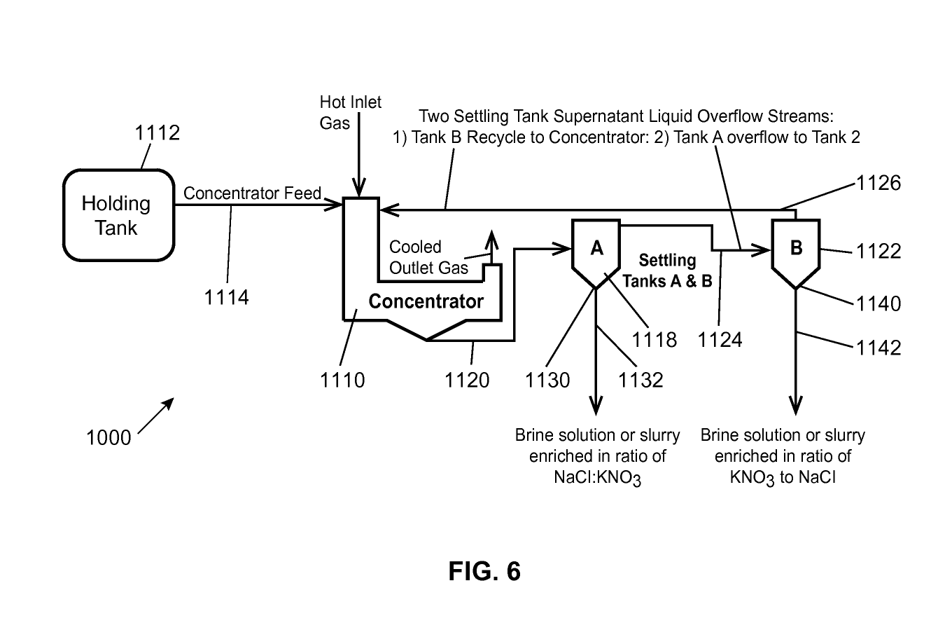

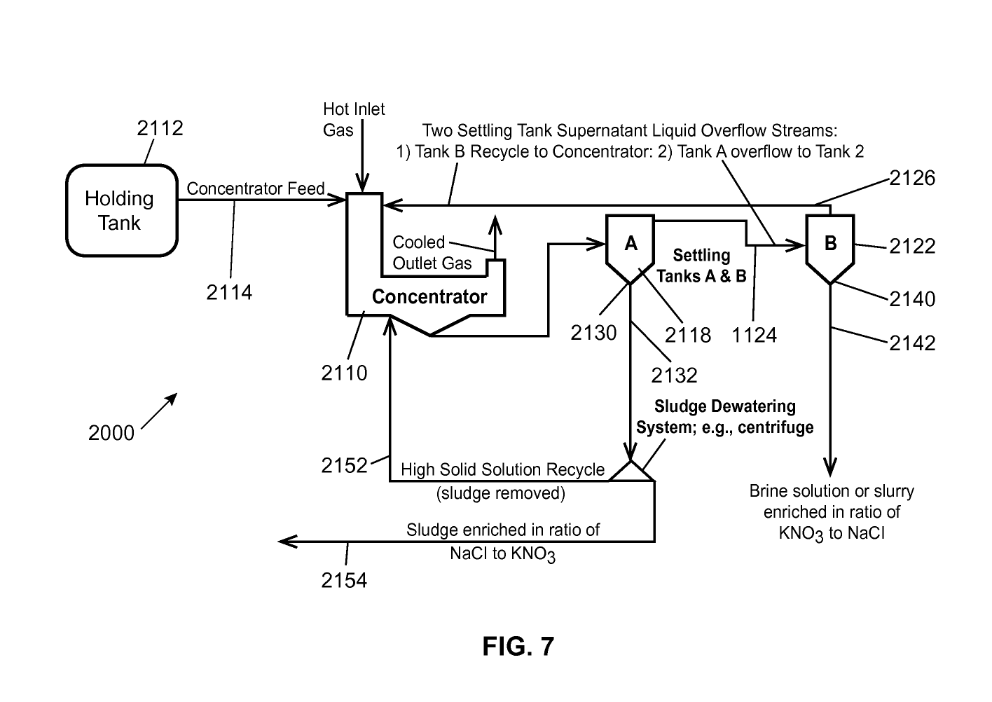

In the selective separation and concentration system described below with respect to FIGS. 6 and 7, the flare 130 and the flare cap assembly 132 are optional and not required. In certain embodiments, the selective separation and concentration system described below may use other sources of heat, which may or may not have need for a flare cap assembly.

If desired, the flare 130 may include an adapter section 138 including the primary combustion gas outlet 143 and a secondary combustion gas outlet 141 upstream of the primary combustion gas outlet 143. When the flare cap 130 is in the closed position, combustion gas is diverted through the secondary combustion gas outlet 141. The adapter section 138 may include a connector section 139 that connects the flare 130 (or exhaust stack) to the heat transfer section 117 using a 90 degree elbow or turn. Other connector arrangements are possible. For example, the flare 130 and heat transfer section 117 may be connected at virtually any angle between 0 degrees and 180 degrees. In this case, the flare cap assembly 132 is mounted on the top of the adaptor section 138 proximate the primary combustion gas outlet 143.

As illustrated in FIGS. 1 and 2, the heat transfer assembly 117 includes a transfer pipe 140, which connects to an inlet of the air pre-treatment assembly 119 to the flare 130 and, more particularly, to the adaptor section 138 of the flare 130. A support member 142, in the form of a vertical bar or pole, supports the heat transfer pipe 140 between the flare 130 and the air pre-treatment assembly 119 at a predetermined level or height above the ground. The heat transfer pipe 140 is connected to the connector section 139 or the adapter section 138 at the secondary combustion gas outlet 141, the transfer pipe forming a portion of a fluid passageway between the adapter section 138 and a secondary process, such as a fluid concentrating process. The support member 142 is typically necessary because the heat transfer pipe 140 will generally be made of metal, such as carbon or stainless steel, and may be refractory lined with materials such as aluminum oxide and/or zirconium oxide, to withstand the temperature of the gas being transferred from the flare 130 to the air pre-treatment assembly 119. Thus, the heat transfer pipe 140 will typically be a heavy piece of equipment. However, because the flare 130, on the one hand, and the air pre-treatment assembly 119 and the concentrator assembly 120, on the other hand, are disposed immediately adjacent to one another, the heat transfer pipe 140 generally only needs to be of a relatively short length, thereby reducing the cost of the materials used in the concentrator 110, as well as reducing the amount of support structure needed to bear the weight of the heavy parts of the concentrator 110 above the ground. As illustrated in FIG. 1, the heat transfer pipe 140 and the air pre-treatment assembly 1119 form an upside-down U-shaped structure.

The air pre-treatment assembly 119 includes a vertical piping section 150 and an ambient air valve disposed at the top of the vertical piping section 150. The ambient air valve (also referred to as a damper or bleed valve) forms a fluid passageway between the heat transfer pipe 140 (or air pre-treatment assembly 119) and the atmosphere. The ambient air valve operates to allow ambient air to flow through a mesh bird screen 152 (typically wire or metal) and into the interior of the air pre-treatment assembly 119 to mix with the hot gas coming from the flare 130. If desired, the air pre-treatment assembly 119 may include a permanently open section proximate to the bleed valve which always allows some amount of bleed air into the air pre-treatment assembly 119, which may be desirable to reduce the size of the required bleed valve and for safety reasons. A pressure blower (not shown) may be connected to the inlet side of the ambient air valve, if desired, to force ambient air through the ambient air valve. If a pressure blower is implemented, the bird screen 152 and permanently open section (if implemented) may be relocated to the inlet side of the pressure blower. While the control of the ambient air or bleed valve will be discussed in greater detail hereinafter, this valve generally allows the gas from the flare 130 to be cooled to a more desirable temperature before entering into the concentrator assembly 120. The air pre-treatment assembly 119 may be supported in part by cross-members 154 connected to the support member 142. The cross-members 154 stabilize the air pre-treatment assembly 119, which is also typically made of heavy carbon or stainless steel or other metal, and which may be refractory-lined to improve energy efficiency and to withstand the high temperature of the gases within this section of the concentrator 110. If desired, the vertical piping section 150 may be extendable to adapt to or account for flares of differing heights so as to make the liquid concentrator 110 easily adaptable to many different flares or to flares of different heights and also to improve efficiency when erecting concentrators by correcting for slight vertical and/or horizontal misalignment of components. This concept is illustrated in more detail in FIG. 1. As shown in FIG. 1, the vertical piping section 150 may include a first section 150A (shown using dotted lines) that rides inside of a second section 150B thereby allowing the vertical piping section 150 to be adjustable in length (height).

Generally speaking, the air pre-treatment assembly 119 operates to mix ambient air provided through the ambient air valve beneath the screen 152 and the hot gas flowing from the flare 130 through the heat transfer pipe 140 to create a desired temperature of gas at the inlet of the concentrator assembly 120.

The liquid concentrator assembly 120 includes a lead-in section 156 having a reduced cross-section at the top end thereof which mates the bottom of the piping section 150 to a quencher 159 of the concentrator assembly 120. The concentrator assembly 120 also includes a first fluid inlet 160, which injects new or untreated liquid to be concentrated, such as landfill leachate, into the interior of the quencher 159. While not shown in FIG. 1, the inlet 160 may include a coarse sprayer with a large nozzle for spraying the untreated liquid into the quencher 159. Because the liquid being sprayed into the quencher 159 at this point in the system is not yet concentrated, and thus has large amount of water therein, and because the sprayer is a coarse sprayer, the sprayer nozzle is not subject to fouling or being clogged by the small particles within the liquid. As will be understood, the quencher 159 operates to quickly reduce the temperature of the gas stream (e.g., from about 900 degrees Fahrenheit to less than 200 degrees Fahrenheit) while performing a high degree of evaporation on the liquid injected at the inlet 160. If desired, but not specifically shown in FIG. 1, a temperature sensor may be located at or near the exit of the piping section 150 or in the quencher 159 and may be used to control the position of the ambient air valve to thereby control the temperature of the gas present at the inlet of the concentrator assembly 120.

As shown in FIGS. 1 and 3, the quencher 159 is connected to liquid injection chamber which is connected to narrowed portion or venturi section 162 which has a narrowed cross section with respect to the quencher 159 and which has a venturi plate 163 (shown in dotted line) disposed therein. The venturi plate 163 creates a narrow passage through the venturi section 162, which creates a large pressure drop between the entrance and the exit of the venturi section 162. This large pressure drop causes turbulent gas flow and shearing forces within the quencher 159 and the top or entrance of the venturi section 162, and causes a high rate of gas flow out of the venturi section 162, both of which lead to thorough mixing of the gas and liquid in the venturi section 162. The position of the venturi plate 163 may be controlled with a manual control rod 165 connected to the pivot point of the plate 163, or via an automatic positioner that may be driven by an electric motor or pneumatic cylinder (not shown in FIG. 3).

A re-circulating pipe 166 extends around opposite sides of the entrance of the venturi section 162 and operates to inject partially concentrated (i.e., re-circulated) liquid into the venturi section 162 to be further concentrated and/or to prevent the formation of dry particulate within the concentrator assembly 120 through multiple fluid entrances located on one or more sides of the flow corridor. While not explicitly shown in FIGS. 1 and 3, a number of pipes, such as three pipes of, for example, ½ inch diameter, may extend from each of the opposites legs of the pipe 166 partially surrounding the venturi section 162, and through the walls and into the interior of the venturi section 162. Because the liquid being ejected into the concentrator 110 at this point is re-circulated liquid, and is thus either partially concentrated or being maintained at a particular equilibrium concentration and more prone to plug a spray nozzle than the less concentrated liquid injected at the inlet 160, this liquid may be directly injected without a sprayer so as to prevent clogging. However, if desired, a baffle in the form of a flat plate may be disposed in front of each of the openings of the ½ diameter pipes to cause the liquid being injected at this point in the system to hit the baffle and disperse into the concentrator assembly 120 as smaller droplets. In any event, the configuration of this re-circulating system distributes or disperses the re-circulating liquid better within the gas stream flowing through the concentrator assembly 120.

The combined hot gas and liquid flows in a turbulent manner through the venturi section 162. As noted above, the venturi section 162, which has a movable venturi plate 163 disposed across the width of the concentrator assembly 120, causes turbulent flow and complete mixture of the liquid and gas, causing rapid evaporation of the discontinuous liquid phase into the continuous gas phase. Because the mixing action caused by the venturi section 162 provides a high degree of evaporation, the gas cools substantially in the concentrator assembly 120, and exits the venturi section 162 into a flooded elbow 164 at high rates of speed. In fact, the temperature of the gas-liquid mixture at this point may be about 160 degrees Fahrenheit.

A weir arrangement (not shown) within the bottom of the flooded elbow 164 maintains a constant level of partially or fully concentrated re-circulated liquid disposed therein. Droplets of re-circulated liquid that are entrained in the gas phase as the gas-liquid mixture exits the venturi section 162 at high rates of speed are thrown outward onto the surface of the re-circulated liquid held within the bottom of the flooded elbow 164 by centrifugal force generated when the gas-liquid mixture is forced to turn 90 degrees to flow into the fluid scrubber 122. Significant numbers of liquid droplets entrained within the gas phase that impinge on the surface of the re-circulated liquid held in the bottom of the flooded elbow 164 coalesce and join with the re-circulated liquid thereby increasing the volume of re-circulated liquid in the bottom of the flooded elbow 164 causing an equal amount of the re-circulated liquid to overflow the weir arrangement and flow by gravity into the sump 172 at the bottom of the fluid scrubber 122. Thus, interaction of the gas-liquid stream with the liquid within the flooded elbow 164 removes liquid droplets from the gas-liquid stream, and also prevents suspended particles within the gas-liquid stream from hitting the bottom of the flooded elbow 164 at high velocities, thereby preventing erosion of the metal that forms the portions of side walls located beneath the level of the weir arrangement and the bottom of the flooded elbow 164.

After leaving the flooded elbow 164, the gas-liquid stream in which evaporated liquid and some liquid and other particles still exist, flows through the fluid scrubber 122 which is, in this case, a cross-flow fluid scrubber. The fluid scrubber 122 includes various screens or filters which serve to remove entrained liquids and other particles from the gas-liquid stream. In one particular example, the cross flow scrubber 122 may include an initial coarse impingement baffle 169 at the input thereof, which is designed to remove liquid droplets in the range of 50 to 100 microns in size or higher. Thereafter, two removable filters in the form of chevrons 170 are disposed across the fluid path through the fluid scrubber 122, and the chevrons 170 may be progressively sized or configured to remove liquid droplets of smaller and smaller sizes, such as 20-30 microns and less than 10 microns. Of course, more or fewer filters or chevrons could be used.

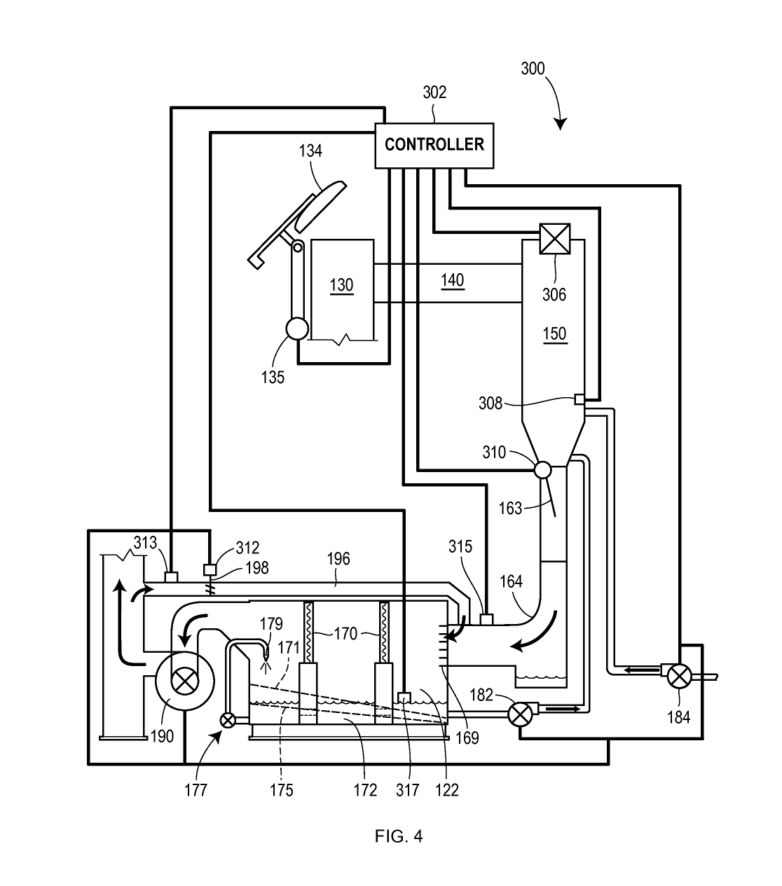

Liquid captured by the filters 169 and 170 and the overflow weir arrangement within the bottom of the flooded elbow 164 drain by gravity into a reservoir or sump 172 located at the bottom of the fluid scrubber 122. The sump 172 thereby collects concentrated fluid containing dissolved and suspended solids removed from the gas-liquid stream and operates as a reservoir for a source of re-circulating concentrated liquid back to the concentrator assembly 120 to be further treated and/or to prevent the formation of dry particulate within the concentrator assembly 120. In one embodiment, the sump 172 may include a sloped V-shaped bottom 171 having a V-shaped groove 175 extending from the back of the fluid scrubber 122 (furthest away from the flooded elbow 164) to the front of the fluid scrubber 122 (closest to the flooded elbow 164), wherein the V-shaped groove 175 is sloped such that the bottom of the V-shaped groove 175 is lower at the end of the fluid scrubber 122 nearest the flooded elbow 164 than at an end farther away from the flooded elbow 164. In other words, the V-shaped bottom 171 may be sloped with the lowest point of the V-shaped bottom 171 proximate the exit port 173 and/or the pump 182. Additionally, a washing circuit 177 (FIG. 4) may pump concentrated fluid from the sump 172 to a sprayer 179 within the cross flow scrubber 122, the sprayer 179 being aimed to spray liquid at the V-shaped bottom 171. Alternatively, the sprayer 179 may spray un-concentrated liquid or clean water at the V-shaped bottom 171. The sprayer 179 may periodically or constantly spray liquid onto the surface of the V-shaped bottom 171 to wash solids and prevent solid buildup on the V-shaped bottom 171 or at the exit port 173 and/or the pump 182. As a result of this V-shaped sloped bottom 171 and washing circuit 177, liquid collecting in the sump 172 is continuously agitated and renewed, thereby maintaining a relatively constant consistency and maintaining solids in suspension. If desired, the spraying circuit 177 may be a separate circuit using a separate pump with, for example, an inlet inside of the sump 172, or may use a pump 182 associated with a concentrated liquid re-circulating circuit described below to spray concentrated fluid from the sump 172 onto the V-shaped bottom 171.

As illustrated in FIG. 1, a return line 180, as well as a pump 182, operates to re-circulate fluid removed from the gas-liquid stream from the sump 172 back to the concentrator 120 and thereby complete a fluid or liquid re-circulating circuit. Likewise, a pump 184 may be provided within an input line 186 to pump new or untreated liquid, such as landfill leachate, to the input 160 of the concentrator assembly 120. Also, one or more sprayers 185 may be disposed inside the fluid scrubber 122 adjacent the chevrons 170 and may be operated periodically to spray clean water or a portion of the wastewater feed on the chevrons 170 to keep them clean.

Concentrated liquid also may be removed from the bottom of the fluid scrubber 122 via the exit port 173 and may be further processed or disposed of in any suitable manner in a secondary re-circulating circuit 181. In particular, the concentrated liquid removed by the exit port 173 contains a certain amount of suspended solids, which preferably may be separated from the liquid portion of the concentrated liquid and removed from the system using the secondary re-circulating circuit 181. For example, concentrated liquid removed from the exit port 173 may be transported through the secondary re-circulating circuit 181 to one or more solid/liquid separating devices 183, such as settling tanks, vibrating screens, rotary vacuum filters, horizontal belt vacuum filters, belt presses, filter presses, and/or hydro-cyclones. After the suspended solids and liquid portion of the concentrated wastewater are separated by the solid/liquid separating device 183, the liquid portion of the concentrated wastewater with suspended particles substantially removed may be returned to the sump 172 for further processing in the first or primary re-circulating circuit connected to the concentrator.

The gas, which flows through and out of the fluid scrubber 122 with the liquid and suspended solids removed therefrom, exits out of piping or ductwork at the back of the fluid scrubber 122 (downstream of the chevrons 170) and flows through an induced draft fan 190 of the exhaust assembly 124, from where it is exhausted to the atmosphere in the form of the cooled hot inlet gas mixed with the evaporated water vapor. Of course, an induced draft fan motor 192 is connected to and operates the fan 190 to create negative pressure within the fluid scrubber 122 so as to ultimately draw gas from the flare 130 through the transfer pipe 140, the air pre-treatment assembly 119 and the concentrator assembly 120. The induced draft fan 190 needs only to provide a slight negative pressure within the fluid scrubber 122 to assure proper operation of the concentrator 110.

While the speed of the induced draft fan 190 can be varied by a device such as a variable frequency drive operated to create varying levels of negative pressure within the fluid scrubber 122 and thus can usually be operated within a range of gas flow capacity to assure complete gas flow from the flare 130, if the gas being produced by the flare 130 is not of sufficient quantity, the operation of the induced draft fan 190 cannot necessarily be adjusted to assure a proper pressure drop across the fluid scrubber 122 itself. That is, to operate efficiently and properly, the gas flowing through the fluid scrubber 122 must be at a sufficient (minimal) flow rate at the input of the fluid scrubber 122. Typically this requirement is controlled by keeping at least a preset minimal pressure drop across the fluid scrubber 122. However, if the flare 130 is not producing at least a minimal level of gas, increasing the speed of the induced draft fan 190 will not be able to create the required pressure drop across the fluid scrubber 122.

To compensate for this situation, the cross flow scrubber 122 is designed to include a gas re-circulating circuit which can be used to assure that enough gas is present at the input of the fluid scrubber 122 to enable the system to acquire the needed pressure drop across the fluid scrubber 122. In particular, the gas re-circulating circuit includes a gas return line or return duct 196 which connects the high pressure side of the exhaust assembly 124 (e.g., downstream of the induced draft fan 190) to the input of the fluid scrubber 122 (e.g., a gas input of the fluid scrubber 122) and a baffle or control mechanism 198 disposed in the return duct 196 which operates to open and close the return duct 196 to thereby fluidly connect the high pressure side of the exhaust assembly 124 to the input of the fluid scrubber 122. During operation, when the gas entering into the fluid scrubber 122 is not of sufficient quantity to obtain the minimal required pressure drop across the fluid scrubber 122, the baffle 198 (which may be, for example, a gas valve, a damper such as a louvered damper, etc.) is opened to direct gas from the high pressure side of the exhaust assembly 124 (i.e., gas that has traveled through the induced draft fan 190) back to the input of the fluid scrubber 122. This operation thereby provides a sufficient quantity of gas at the input of the fluid scrubber 122 to enable the operation of the induced draft fan 190 to acquire the minimal required pressure drop across the fluid scrubber 122.

The liquid concentrator 110 is a very fast-acting concentrator. Because the concentrator 110 is a direct contact type of concentrator (e.g., a discontinuous liquid phase is injected into a continuous gas phase without intermediate heat exchanger surfaces), it is not subject to deposit buildup, clogging and fouling to the same extent as most other concentrators.

FIG. 4 illustrates a schematic diagram of a control system 300 that may be used to operate the concentrator 110 of FIG. 1. As illustrated in FIG. 4, the control system 300 includes a controller 302, which may be a form of digital signal processor type of controller, a programmable logic controller (PLC) which may run, for example, ladder logic based control, or any other type of controller. The controller 302 is, of course, connected to various components within the concentrator 110. In particular, the controller 302 is connected to the flare cap drive motor 135, which controls the opening and closing operation of the flare cap 134. The motor 135 may be set up to control the flare cap 134 to move between a fully open and a fully closed position. However, if desired, the controller 302 may control the drive motor 135 to open the flare cap 134 to any of a set of various different controllable positions between the fully opened and the fully closed position. The motor 135 may be continuously variable if desired, so that the flare cap 134 may be positioned at any desired point between fully open and fully closed.

Additionally, the controller 302 is connected to and controls the ambient air inlet valve 306 disposed in the air pre-treatment assembly 119 of FIG. 1 upstream of the venturi section 162 and may be used to control the pumps 182 and 184 which control the amount of and the ratio of the injection of new liquid to be treated and the re-circulating liquid being treated within the concentrator 110. The controller 302 may be operatively connected to a sump level sensor 317 (e.g., a float sensor, a non-contact sensor such as a radar or sonic unit, or a differential pressure cell). The controller 302 may use a signal from the sump level sensor 317 to control the pumps 182 and 184 to maintain the level of concentrated fluid within the sump 172 at a predetermined or desired level. Also, the controller 302 may be connected to the induced draft fan 190 to control the operation of the fan 190, which may be a single speed fan, a variable speed fan or a continuously controllable speed fan. In one embodiment, the induced draft fan 190 is driven by a variable frequency motor, so that the frequency of the motor is changed to control the speed of the fan. Moreover, the controller 302 is connected to a temperature sensor 308 disposed at, for example, the inlet of the concentrator assembly 120 or at the inlet of the venturi section 162, and receives a temperature signal generated by the temperature sensor 308. The temperature sensor 308 may alternatively be located downstream of the venturi section 162 or the temperature sensor 308 may include a pressure sensor for generating a pressure signal.

During operation and at, for example, the initiation of the concentrator 110, when the flare 130 is actually running and is thus burning gas, the controller 302 may first turn on the induced draft fan 190 to create a negative pressure within the fluid scrubber 122 and the concentrator assembly 120. The controller 302 may then or at the same time, send a signal to the motor 135 to close the flare cap 134 either partially or completely, to direct waste heat from the flare 130 into the transfer pipe 140 and thus to the air pre-treatment assembly 119. Based on the temperature signal from the temperature sensor 308, the controller 302 may control the ambient air valve 306 (typically by closing this valve partially or completely) and/or the flare cap actuator to control the temperature of the gas at the inlet of the concentrator assembly 120. Generally speaking, the ambient air valve 306 may be biased in a fully open position (i.e., may be normally open) by a biasing element such as a spring, and the controller 302 may begin to close the valve 306 to control the amount of ambient air that is diverted into the air pre-treatment assembly 119 (due to the negative pressure in the air pre-treatment assembly 119), so as to cause the mixture of the ambient air and the hot gases from the flare 130 to reach a desired temperature. Additionally, if desired, the controller 302 may control the position of the flare cap 134 (anywhere from fully open to fully closed) and may control the speed of the induced draft fan 190, to control the amount of gas that enters the air pre-treatment assembly 119 from the flare 130. As will be understood, the amount of gas flowing through the concentrator 110 may need to vary depending on ambient air temperature and humidity, the temperature of the flare gas, the amount of gas exiting the flare 130, etc. The controller 302 may therefore control the temperature and the amount of gas flowing through the concentrator assembly 120 by controlling one or any combination of the ambient air control valve 306, the position of the flare cap 134 and the speed of the induced draft fan 190 based on, for example, the measurement of the temperature sensor 308 at the inlet of the concentrator assembly 120. This feedback system is desirable because, in many cases, the air coming out of a flare 130 is between 1200 and 1800 degrees Fahrenheit, which may be too hot, or hotter than required for the concentrator 110 to operate efficiently and effectively.

In any event, as illustrated in FIG. 4, the controller 302 may also be connected to a motor 310 which drives or controls the position of the venturi plate 163 within the narrowed portion of the concentrator assembly 120 to control the amount of turbulence caused within the concentrator assembly 120. Still further, the controller 302 may control the operation of the pumps 182 and 184 to control the rate at which (and the ratio at which) the pumps 182 and 184 provide re-circulating liquid and new waste fluid to be treated to the inputs of the quencher 159 and the venturi section 162. In one embodiment, the controller 302 may control the ratio of the re-circulating fluid to new fluid to be about 10:1, so that if the pump 184 is providing 8 gallons per minute of new liquid to the input 160, the re-circulating pump 182 is pumping 80 gallons per minute. Additionally, or alternatively, the controller 302 may control the flow of new liquid to be processed into the concentrator (via the pump 184) by maintaining a constant or predetermined level of concentrated liquid in the sump 172 using, for example, the level sensor 317. Of course, the amount of liquid in the sump 172 will be dependent on the rate of concentration in the concentrator, the rate at which concentrated liquid is pumped from or otherwise exists the sump 172 via the secondary re-circulating circuit and the rate at which liquid from the secondary re-circulating circuit is provided back to the sump 172, as well as the rate at which the pump 182 pumps liquid from the sump 172 for delivery to the concentrator via the primary re-circulating circuit.

Furthermore, as illustrated in the FIG. 4, the controller 302 may be connected to the venturi plate motor 310 or other actuator which moves or actuates the angle at which the venturi plate 163 is disposed within the venturi section 162. Using the motor 310, the controller 302 may change the angle of the venturi plate 163 to alter the gas flow through the concentrator assembly 120, thereby changing the nature of the turbulent flow of the gas through concentrator assembly 120, which may provide for better mixing of the and liquid and gas therein and obtain better or more complete evaporation of the liquid. In this case, the controller 302 may operate the speed of the pumps 182 and 184 in conjunction with the operation of the venturi plate 163 to provide for optimal concentration of the wastewater being treated. Thus, as will be understood, the controller 302 may coordinate the position of the venturi plate 163 with the operation of the flare cap 134, the position of the ambient air or bleed valve 306, and the speed of the induction fan 190 to maximize wastewater concentration (turbulent mixing) without fully drying the wastewater so as to prevent formation of dry particulates. The controller 302 may use pressure inputs from the pressure sensors to position the venturi plate 163. Of course, the venturi plate 163 may be manually controlled or automatically controlled.

The controller 302 may also be connected to a motor 312 which controls the operation of the damper 198 in the gas re-circulating circuit of the fluid scrubber 122. The controller 302 may cause the motor 312 or other type of actuator to move the damper 198 from a closed position to an open or to a partially open position based on, for example, signals from pressure sensors 313, 315 disposed at the gas entrance and the gas exit of the fluid scrubber 122. The controller 302 may control the damper 198 to force gas from the high pressure side of the exhaust section 124 (downstream of the induced draft fan 190) into the fluid scrubber entrance to maintain a predetermined minimum pressure difference between the two pressure sensors 313, 315. Maintaining this minimum pressure difference assures proper operation of the fluid scrubber 122. Of course, the damper 198 may be manually controlled instead or in addition to being electrically controlled.

The liquid concentrator 110 provides direct contact of the liquid to be concentrated and the hot gas, effecting highly turbulent heat exchange and mass transfer between hot gas and the liquid, e.g., wastewater, undergoing concentration. Moreover, the concentrator 110 employs highly compact gas-liquid contact zones, making it minimal in size as compared to known concentrators. The direct contact heat exchange feature promotes high energy efficiency and eliminates the need for solid surface heat exchangers as used in conventional, indirect heat transfer concentrators. Further, the compact gas-liquid contact zone eliminates the bulky process vessels used in both conventional indirect and direct heat exchange concentrators. These features allow the concentrator 110 to be manufactured using comparatively low cost fabrication techniques and with reduced weight as compared to conventional concentrators. Both of these factors favor portability and cost-effectiveness. Thus, the liquid concentrator 110 is more compact and lighter in weight than conventional concentrators. Additionally, the liquid concentrator 110 is less prone to fouling and blockages due to the direct contact heat exchange operation and the lack of solid heat exchanger surfaces. The liquid concentrator 110 can also process liquids with significant amounts of suspended solids because of the direct contact heat exchange. As a result, high levels of concentration of the process fluids may be achieved without need for frequent cleaning of the concentrator 110.

More specifically, in liquid concentrators that employ indirect heat transfer, the heat exchangers are prone to fouling and are subject to accelerated effects of corrosion at the normal operating temperatures of the hot heat transfer medium that is circulated within them (steam or other hot fluid). Each of these factors places significant limits on the durability and/or costs of building conventional indirectly heated concentrators, and on how long they may be operated before it is necessary to shutdown and clean or repair the heat exchangers. By eliminating the bulky process vessels, the weight of the liquid concentrators and both the initial costs and the replacement costs for high alloy components are greatly reduced. Moreover, due to the temperature difference between the gas and liquid, the relatively small volume of liquid contained within the system, and the reduced relative humidity of the gas prior to mixing with the liquid, the concentrator 10 operates at close to the adiabatic saturation temperature for the particular gas/liquid mixture, which is typically in the range of about 150 degrees Fahrenheit to about 215 degrees Fahrenheit (i.e., this concentrator is a “low momentum” concentrator).

The above described liquid concentrators may be useful in separating and concentrating water soluble salts in wastewater. In particular, the described liquid concentrators may be useful in separating salts of sodium, calcium, magnesium, potassium, sulfate and chloride, and more specifically, sodium chloride, calcium chloride, strontium chloride, barium chloride, magnesium chloride, sodium sulfate, magnesium sulfate, and calcium sulfate.

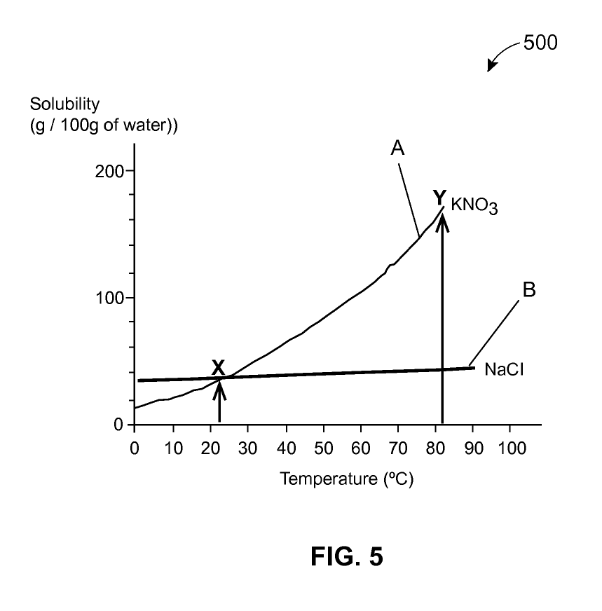

FIG. 5 is a graph 500 of solubility vs. temperature for two example water soluble salts, sodium chloride and potassium nitrate. The x-axis is temperature in ° C. and the y-axis is solubility in g/100 g of water. Line A illustrates the solubility curve for potassium nitrate and line B illustrates the solubility curve of sodium chloride. Point X represents a crossover point where the solubility of potassium nitrate and the solubility of sodium chloride are equal, which occurs at about 24° C. Point Y represents relative solubilities at a higher temperature, approximately 82° C. As temperature increases, potassium nitrate becomes much more soluble than sodium chloride. These solubility differences may be exploited in the selective separation and concentration system described below.

A first embodiment of a selective separation and concentration system 1000 is illustrated in FIG. 6. The selective separation and concentration system 1000 includes a liquid concentrator 1110, which may be a direct contact liquid concentrator, such as the direct contact liquid concentrators described above. A holding tank 1112 may feed liquid into the concentrator 1110 through a feed input line 1114. The feed liquid may include two or more water soluble salts dissolved therein, thereby forming a homogeneous mixture of the two or more dissolved salts. Partially concentrated feed liquid is drawn from a sump 1116 of the liquid concentrator 1110 and sent to a first settling tank 1118 via a first partially concentrated feed line 1120. Similarly, partially concentrated feed liquid is drawn from the first settling tank 1118 and sent to a second settling tank 1122 via a second partially concentrated feed line 1124. A return line 1126 returns partially concentrated feed liquid to the concentrator 1110 for further concentration, if needed.

As the feed liquid warms during the concentration process in the concentrator, the relative solubilities of the two salts change. The feed liquid is continuously circulated through the concentrator 1110, the first settling tank 1118, and the second settling tank 1122, until the partially concentrated feed liquid reaches a saturation point of the first dissolved salt. At this point, the first dissolved salt will begin to precipitate out of solution due to saturation of the solution. The precipitated first salt will settle out of the solution predominantly in the first settling tank 1118 (although a small portion of the second salt may also precipitate in the first settling tank 1118). The partially concentrated feed liquid delivered to the second settling tank 1112, thereafter will contain a different ratio of first to second salts when compared to the unconcentrated feed liquid (because some of the first salt has been removed from the solution through precipitation in the first settling tank). A slurry enriched in the ratio of the first salt vs. the second salt may be drawn off of the first settling tank 1112 through a first extraction port 1130 and a first extraction line 1132. Similarly, a brine solution enriched in the ratio of the second salt vs. the first salt may be drawn off of the second settling tank 1122 through a second extraction portion 1140 and a second extraction line 1142.

The relative ratios of the first salt to the second salt may be selected by adjusting the operating temperature of the concentrator 1110. For example, if the temperature is increased, more of the second salt may remain dissolved in the solution while the first salt precipitates out of the solution. As a result, higher concentrations of the first salt may remain relative to the second salt. Conversely, if the temperature is decreased, less of the second salt remains dissolved in the solution and a lower concentration of the first salt may remain relative to the second salt.

The relative ratios of the first salt to the second salt may also be selected by adjusting the rate of withdrawal of sludge of fluid through the first extraction port 1130 and the second extraction port 1140. Decreasing a withdrawal rate of slurry from the first extraction port 1130 will reduce the amount of the first salt that is drawn off, which will generally raise the ratio of the first salt to the second salt. Similarly, decreasing a withdrawal rate of brine solution from the second extraction port 1140 will raise the ratio of the second salt to the first salt. Decreasing a withdrawal rate from both the first extraction port 1130 and the second extraction port 1140, will generally tend to raise the concentration of the first salt in the first extraction line 1132 and the concentration of the second salt in the second extraction line 1142. All of these variables may be controlled by an operator to produce 1) a desired ratio of first salt to second salt in the first extraction line 1132, 2) a desired ratio of first salt to second salt in the second extraction line 1142, and 3) a desired ratio of first salt to second salt in the return line 1126. As a result, the two water soluble salts can be separated (at least partially) from one another and relative concentrations of the two salts may be precisely controlled.

In an alternate embodiment, one or both of the first settling tank 1118 and the second settling tank 1122 may include a temperature controlling means, such as a heating or cooling blanket, or a heating or cooling element, to further facilitate precipitation of the desired salt.

In yet other embodiments, three or more settling tanks may be included to separate or concentrate three or more dissolved salts.

A second embodiment of a selective separation and concentration system 2000 is illustrated in FIG. 7. Elements in the embodiment of FIG. 7 that are similar to those illustrated in FIG. 6 are numbered exactly 2000 greater than the corresponding elements in FIG. 6.

In addition to the elements of the embodiment of FIG. 6, the selective separation and concentration system 2000 of FIG. 7 includes a sludge dewatering system 2150, a solids solution recycle line 2152, and an enriched sludge line 2154. The sludge drawn off from the first extraction port 2130, through the first extraction line 2132 may contain a relatively large amount of liquid solution, in addition to the precipitated salts described above. The sludge dewatering system 2150, which may take the form of a centrifuge, separates a portion of the remaining liquid from the precipitated salt solids. The liquid portion may be returned to the concentrator 2110 through the high solids solution recycle line 2152, for further concentration, while the enriched sludge may be drawn off through the enriched sludge line 2154, for further processing or disposal.

Generally, a process for separating or concentrating water soluble salts in a wastewater stream includes 1) delivering to a concentrator unconcentrated feed liquid including a first water soluble salt dissolved in the feed liquid and a second water soluble salt dissolved in the feed liquid, 2) evaporating a liquid portion of the wastewater in the concentrator, thereby producing a concentrated wastewater stream, 3) continuing to concentrate the concentrated wastewater stream until the concentrated wastewater stream approaches or reaches a saturation level of the first water soluble salt, 4) delivering the concentrated wastewater to a first settling tank, where the first water soluble salt begins to precipitate out of solution in solid form, 5) drawing a sludge from the first settling tank, the sludge having an elevated ratio of the first water soluble salt to the second water soluble salt when compared to the unconcentrated feed liquid, 6) drawing a first liquid solution from the first settling tank and sending the liquid solution to a second settling tank, 7) drawing a second liquid solution from the second settling tank, the second liquid solution having an elevated ratio of the second water soluble salt to the first water soluble salt when compared to the unconcentrated liquid, and 8) drawing a third liquid solution from the second settling tank and delivering the third liquid solution to the concentrator for further concentration.

In one example, the unconcentrated solution includes a holding tank containing 1,000,000 kg of water at approximately 24° C. Equal weights (370,000 kg) of KNO₃ and NaCl were dissolved in the water, thereby producing a ratio of KNO₃ to NaCl of 1:1. Using the system described above, the water may be concentrated until the concentration of NaCl reaches the saturation point. NaCl will begin to precipitate out of solution in the first settling tank 1118. Sludge drawn off through the first extraction port 1130 will include a ratio of KNO₃ to NaCl that is less than 1:1 because most of the KNO₃ will remain in solution while some of the NaCl will precipitate out into the sludge. Solution drawn off from the second extraction port 1140 will include a ratio of KNO₃ to NaCl that is greater than 1:1 because most of the KNO₃ will remain in solution while some of the NaCl will precipitate out into the sludge in the first settling tank. If the withdrawal rate of the sludge through the first extraction port 1130 is decreased, the ratio of KNO₃ to NaCl would fall as the sludge would contain more NaCl. Conversely, if the withdrawal rate of the solution through the second extraction port 1140 is decreased, the ratio of KNO₃ to NaCl would rise.

On the other hand, increasing the withdrawal rate of the sludge through the first extraction port 1130 would tend to raise the ratio of KNO₃ to NaCl. Conversely, increasing the withdrawal rate of the solution through the second extraction port 1140 would tend to lower the ratio of KNO₃ to NaCl.

While certain representative embodiments and details have been shown for purposes of illustrating the invention, it will be apparent to those skilled in the art that various changes in the methods and apparatus disclosed herein may be made without departing from the scope of the invention.

1. A selective separation and concentration system for water soluble salts, the system comprising:
a holding tank for containing a feed liquid that includes at least two water soluble salts dissolved therein in a first concentration ratio;
a liquid concentrator, the liquid concentrator evaporating a portion of the feed liquid, thereby concentrating the dissolved salts while maintaining the first concentration ratio;
a first partially concentrated feed line adapted to extract partially concentrated feed liquid from the concentrator,
a first settling tank connected to the first partially concentrated feed line, the first settling tank being adapted to hold a volume of partially concentrated feed liquid;
a second partially concentrated feed line connected to the first settling tank and adapted to extract partially concentrated feed liquid from the first settling tank;
a second settling tank connected to the second partially concentrated feed line, the second settling tank being adapted to hold a volume of partially concentrated feed liquid; and
a return line fluidly connected to the second settling tank and to the concentrator, the return line being adapted to return partially concentrated feed liquid to the concentrator.

2. The selective separation and concentration system of claim 1, further comprising a first extraction port in the first settling tank, the first extraction port being adapted to remove sludge from the first settling tank.

3. The selective separation and concentration system of claim 2, further comprising a first controllable valve connected to the first extraction port, the first controllable valve controlling the rate of fluid extraction through the first extraction port.

4. The selective separation and concentration system of claim 2, further comprising a second extraction port in the second settling tank, the second extraction port being adapted to remove solution from the second settling tank.

5. The selective separation and concentration system of claim 4, further comprising a second controllable valve connected to the second extraction port, the second controllable valve controlling the rate of fluid extraction through the second extraction port

6. The selective separation and concentration system of claim 2, further comprising a sludge dewatering system fluidly connected to the first extraction port.

7. The selective separation and concentration system of claim 6, wherein the sludge dewatering system is a centrifuge.

8. The selective separation and concentration system of claim 6, further comprising a solids solution recycle line fluidly connected to the sludge dewatering system and to the concentrator.

9. The selective separation and concentration system of claim 6, further comprising an enriched sludge extraction line fluidly connected to the sludge dewatering system.

10. The selective separation and concentration system of claim 1, wherein one of the first settling tank and the second settling tank includes a solution temperature controlling device.

11. The selective separation and concentration system of claim 10, wherein the solution temperature controlling device is a heating blanket.

12. The selective separation and concentration system of claim 10, wherein the solution temperature controlling device is a cooling blanket.

13. The selective separation and concentration system of claim 10, wherein the solution temperature controlling device is a heating element.

14. The selective separation and concentration system of claim 10, wherein the solution temperature controlling device is a cooling element.

15. A process for separating or concentrating water soluble salts in a wastewater stream, the process comprising:
delivering to a concentrator unconcentrated feed liquid including a first water soluble salt dissolved in the feed liquid and a second water soluble salt dissolved in the feed liquid, the unconcentrated feed liquid having a first ratio of the first water soluble salt to the second water soluble salt;
evaporating a liquid portion of the wastewater in the concentrator, thereby producing a concentrated wastewater stream;
continuing to concentrate the concentrated wastewater stream until the concentrated wastewater stream approaches or reaches a saturation level of the first water soluble salt;
delivering the concentrated wastewater to a first settling tank, where the first water soluble salt begins to precipitate out of solution in solid form;
drawing a sludge from the first settling tank, the sludge having a second ratio of the first water soluble salt to the second water soluble salt, the second ratio being less than the first ratio;
drawing a first liquid solution from the first settling tank and sending the liquid solution to a second settling tank;
drawing a second liquid solution from the second settling tank, the second liquid solution having third ratio of the first water soluble salt to the second water soluble salt, the third ratio being larger than the first ratio; and
drawing a third liquid solution from the second settling tank and delivering the third liquid solution to the concentrator for further concentration.
